(19) United States
(12) Patent Application Publication
(10) Pub. No.: US 2019/0343140 A1
(43) Pub. Date: Nov. 14, 2019

(54) FOOD-RELATED USES OF HIGH-STABILITY OIL

(71) Applicant: Corbion Biotech, Inc., South San Francisco, CA (US)

(72) Inventors: Walter Rakitsky, San Diego, CA (US); Risha Bond, Mountain View, CA (US); Alexandra Connell, San Francisco, CA (US); Beata Klamczynska, Orinda, CA (US); Alejandro Marangoni, Guelph (CA)

(21) Appl. No.: 16/422,855

(22) Filed: May 24, 2019

Related U.S. Application Data
(63) Continuation of application No. 14/693,853, filed on Apr. 22, 2015, now abandoned.
(60) Provisional application No. 61/988,008, filed on May 2, 2014.
(60) Provisional application No. 61/983,292, filed on Apr. 23, 2014.

(51) Int. Cl. A23D 7/00; A23D 9/007; C11B 5/00; A23B 7/16; A23D 7/005; A23L 19/18; A23L 5/10

(52) U.S. Cl. CPC A23D 7/001; A23D 9/007; C11B 5/0092; C11B 5/0085; A23V 2002/00; A23B 7/16; A23D 7/0056; A23L 19/18; A23L 5/11; C11B 5/0021

(57) ABSTRACT

The invention provides for methods and foods with reduced or no chelating agents. The present invention also relates to methods for using high stability oils including high-stability high-oleic oils produced using genetically engineered microalgae. The oils can be used in multiple food-related applications including frying, spray-coating, and lubrication of equipment. The oils can also be blended with vegetable oils or interesterified with vegetable oils.

### CROSS-REFERENCE TO RELATED APPLICATIONS

This application is a continuation of U.S. patent application Ser. No. 14/693,853, filed Apr. 22, 2015, which claims the benefit under 35 U.S.C. 119(e) of US Provisional Patent Application Nos. 61/983,292, filed Apr. 23, 2014, and 61/988,008, filed May 2, 2014, each of which is incorporated herein by reference in its entirety for all purposes.

### TECHNICAL FIELD

The present invention relates to foods and methods of preparing or enhancing functional properties of foods using high oleic and/or high stability oils produced by genetically engineered cells.

### BACKGROUND

Recently, recombinant cells have been produced that allow for the production of triglyceride oils having fatty acid profiles that are exceptionally low in polyunsaturated fatty acids and/or exceptionally high in oleic acid. Details on the production of such cells and oils are provided in WIPO publications WO2011/150411, WO2012/106560, and WO2013/158938.

### SUMMARY

In one aspect, the present invention provides a method of reducing or eliminating the addition of a chelating agent to a food product comprising: (a)reducing or eliminating the use of the chelating agent; (b) reducing or eliminating the use of a vegetable oil or animal fat; and/or (c) replacing a portion or all of the vegetable oil or animal fat with high stability oil or high stability high oleic oil, wherein the food product has a shelf life that is at least 10% greater than a reference food comprising a chelating agent and a vegetable oil or animal fat. In some cases the chelating agent is ethylenediamintetraacetic acid.

In another aspect, the present invention provides a food product comprising a reduced amount of or no chelating agent and high stability oil or high stability high oleic oil, wherein the food product has a shelf life that is at least 10% greater than a reference food comprising a chelating agent and a vegetable oil or animal fat. In some cases, the chelating agent is ethylenediamintetraacetic acid.

In related embodiments, the predominant sterol present in the high stability or high stability high oleic oil is a C28 sterol. In some cases, the C28 sterol is ergosterol.

In another aspect, the present invention provides a margarine comprising a vegetable or animal hardstock fat and high stability or high stability high oleic oil wherein the saturated fat content of the margarine is reduced by at least 10% from a reference margarine made with a vegetable or animal hardstock fat and a vegetable or animal liquid oil. In some cases, the saturated fat content of the margarine is reduced by at least 30% from a reference margarine made with a vegetable or animal hardstock fat and a vegetable or animal liquid oil.

In another aspect, the present invention provides a margarine comprising an algal hardstock fat and high stability or high stability high oleic oil wherein the saturated fat content of the margarine is reduced by at least 10% from a reference margarine made with a vegetable or animal hardstock fat and a vegetable or animal liquid oil. In some cases, the saturated fat content of the margarine is reduced by at least 30% from a reference margarine made with a vegetable or animal hardstock fat and a vegetable or animal liquid oil. In some cases, the saturated fat content of the margarine is reduced by at least 50% from a reference margarine made with a vegetable or animal hardstock fat and a vegetable or animal liquid oil. In related embodiments, the hardstock fat comprises at least 40% SOS triacylglycerides.

In another aspect, the present invention provides a method of making a margarine comprising blending: (a) a hardstock fat, wherein the hardstock fat is optionally an algal oil; (b) high stability or high stability high oleic oil; and (c) water, wherein the saturated fat content of the margarine is reduced by at least 10% from a reference margarine made with a vegetable or animal hardstock fat and a vegetable or animal liquid oil. In some cases, the hardstock fat is an algal oil. In some embodiments, the algal oil comprises at least 40% SOS triglycerides.

In related embodiments, the saturated fat content of the margarine is reduced by at least 30% from a reference margarine made with a vegetable or animal hardstock fat and a vegetable or animal liquid oil. In some cases, the saturated fat content of the margarine is reduced by at least 50% from a reference margarine made with a vegetable or animal hardstock fat and a vegetable or animal liquid oil.

In another aspect, the present invention provides a method includes providing an HS or HSHO oil and frying a snack chip. The method includes heating the chip to frying temperature in the oil; coating an optionally dehydrated, food item with the oil; dissolving a flavor or color in the oil; lubricating food-processing machinery with the oil; canning seafood in the oil; producing an emulsified product with the oil; baking a baked good with the oil; drying the oil to produce a nutritional supplement; adding the oil to a dairy replacement or meal replacement; enzymatically interesterifying a blend of the oil with a vegetable oil; blending the oil with a hardstock fat, avocado oil, walnut oil, olive oil, palm oil, palm kernel oil, palm stearine, coconut oil, cottonseed oil, peanut oil, canola oil, safflower oil, corn oil, soybean oil, lard, tallow, butter; frying dough in the oil or in a blend of the oil with a palm-kernel based hardstock fat; or transesterifying the oil with fatty acid, triglycerides, or fatty acid esters to produce a cocoa butter equivalent.

In a related embodiment, a dehydrated food item is coated with the oil and later rehydrated and optionally cooked. When cooked, the food can have an improved mouthfeel.

In a related embodiment, a food product is produced by one of the above methods. Optionally, the shelf-life of the food item is extended by at least 10% relative to frying in commodity soybean oil. Optionally, due to the extended shelf life, the snack chip or the baked good is packaged without nitrogen sparging.

In a related embodiment, the oil is transesterified with fatty acid, triglycerides, or fatty acid esters to produce a cocoa butter equivalent and the oil is produced from a recombinant microalga comprising recombinant nucleic acids operable to reduce the expression of at least one FATA allele, overexpress at least one KASII allele and/or decrease expression of at least one FADc allele

In an embodiment a food product is a fried snack chip product, a fried dough product, a dehydrated food item, canned seafood, baked good, dairy replacement, or meal replacement comprising HS or HSHO oil wherein the predominant sterol present in the HS or HSHO oil is a C28 sterol. The C28 sterol is ergosterol.

### BRIEF DESCRIPTION OF THE DRAWINGS

FIG. 1 shows differential scanning calorimetry traces, at multiple time points, of a transesterification reaction to make a cocoa butter equivalent.

FIG. 2 is a photograph showing the stability testing results of mayonnaise made with soybean oil or HSHO oil, both made without the addition of EDTA.

### DETAILED DESCRIPTION OF EMBODIMENTS OF THE INVENTION

### Definitions:

An “allele” refers to a copy of a gene where an organism has multiple similar or identical gene copies, even if on the same chromosome. An allele may encode the same or similar protein.

A “natural oil” or “natural fat” shall mean a predominantly triglyceride oil obtained from an organism, where the oil has not undergone blending with another natural or synthetic oil, or fractionation so as to substantially alter the fatty acid profile of the triglyceride. In connection with an oil comprising triglycerides of a particular regiospecificity, the natural oil or natural fat has not been subjected to interesterification or other synthetic process to obtain that regiospecific triglyceride profile, rather the regiospecificity is produced by a cell or population of cells. For a natural oil produced by a cell, the sterol profile of oil is generally determined by the sterols produced by the cell, not by artificial reconstitution of the oil by adding sterols in order to mimic the natural oil. In connection with a natural oil or natural fat, and as used generally throughout the present disclosure, the terms oil and fat are used interchangeably, except where otherwise noted. Thus, an “oil” or a “fat” can be liquid, solid, or partially solid at room temperature, depending on the makeup of the substance and other conditions. Here, the term “fractionation” means removing material from the oil in a way that changes its fatty acid profile relative to the fatty acid profile as produced by the organism, however accomplished. The terms “natural oil” and “natural fat” encompass such oils obtained from an organism, where the oil has undergone minimal processing, including refining, bleaching and/or degumming, which does not substantially change its triglyceride profile. A natural oil can also be a “noninteresterified natural oil”, which means that the natural oil has not undergone a process in which fatty acids have been redistributed in their acyl linkages to glycerol and remain essentially in the same configuration as when recovered from the organism.

“Cellulosic material” is a biological material comprising cellulose and optionally hemicellulose. As such it is digestible to sugars such as glucose and xylose, and optionally may comprise additional compounds such as disaccharides, oligosaccharides, lignin, furfurals and other compounds. Nonlimiting examples of sources of cellulosic material include sugar cane bagasses, sugar beet pulp, corn stover, wood chips, sawdust and switchgrass.

“Exogenous gene” shall mean a nucleic acid that codes for the expression of an RNA and/or protein that has been introduced into a cell (e.g. by transformation/transfection), and is also referred to as a “transgene”. A cell comprising an exogenous gene may be referred to as a recombinant cell, into which additional exogenous gene(s) may be introduced. The exogenous gene may be from a different species (and so heterologous), or from the same species (and so homologous), relative to the cell being transformed. Thus, an exogenous gene can include a homologous gene that occupies a different location in the genome of the cell or is under different control, relative to the endogenous copy of the gene. An exogenous gene may be present in more than one copy in the cell. An exogenous gene may be maintained in a cell as an insertion into the genome (nuclear or plastid) or as an episomal molecule.

“Fatty acids” shall mean free fatty acids, fatty acid salts, or fatty acyl moieties in a glycerolipid. It will be understood that fatty acyl groups of glycerolipids can be described in terms of the carboxylic acid or anion of a carboxylic acid that is produced when the triglyceride is hydrolyzed or saponified.

“Fixed carbon source” is a molecule(s) containing carbon, typically an organic molecule that is present at ambient temperature and pressure in solid or liquid form in a culture media that can be utilized by a microorganism cultured therein. Accordingly, carbon dioxide is not a fixed carbon source. Examples of fixed carbon sources include C6 and C5 sugars including glucose, dextrose, fructose, xylose and other sugars. In addition, the disaccharide sucrose which is a dimer of glucose and fructose is one example of a fixed carbon source. The depolymerization of cellulosic materials also provides sugars and thus provides a fixed carbon in the form of glucose and/or xylose and other sugars.

“HS oil” or “High Stability Oil” shall mean an oil produced from a recombinant cell that has a fatty acid profile with less than 5% polyunsaturated fatty acids and encompasses embodiments that have less than 4%, 3%, 2%, 1%, 0.5%, or substantially no polyunsaturated fatty acids. Unless otherwise specified, HS oil is a natural oil.

“HSHO oil” or “High stability high oleic oil” is an HS oil with a fatty acid profile of greater than 75% oleic acid but also encompasses oils with greater than 80% or 85% oleic acid. Unless otherwise specified, HSHO oil is a natural oil.

“Hardstock fat” is an oil that has a solid fat content of at least 50% under standard ambient temperature and conditions (20° C-30° C. and 0.95 -1.05 atm).

A “monounsaturated fatty acid” or “MUFA” is a fatty acid that contains only one double bond. Oleic acid (C18:1) is a MUFA and is present in olive oil, for example.

“In operable linkage” is a functional linkage between two nucleic acid sequences, such as a control sequence (typically a promoter) and the linked sequence (typically a sequence that encodes a protein, also called a coding sequence). A promoter is in operable linkage with an exogenous gene if it can mediate transcription of the gene.

“Liquid Oil” is an oil that is a liquid under standard ambient temperature and conditions (20° C.-30° C. and 0.95 -1.05 atm).

“Microalgae” are eukaryotic microbial organisms that contain a chloroplast or other plastid, and optionally that is capable of performing photosynthesis, or a prokaryotic microbial organism capable of performing photosynthesis. Microalgae include obligate photoautotrophs, which cannot metabolize a fixed carbon source as energy, as well as heterotrophs, which can live solely off of a fixed carbon source. Microalgae include unicellular organisms that separate from sister cells shortly after cell division, such as Chlamydomonas, as well as microbes such as, for example, Volvox, which is a simple multicellular photosynthetic microbe of two distinct cell types. Microalgae include cells such as Chlorella, Dunaliella, and Prototheca. Microalgae also include other microbial photosynthetic organisms that exhibit cell-cell adhesion, such as Agmenellum, Anabaena, and Pyrobotrys. Microalgae also include obligate heterotrophic microorganisms that have lost the ability to perform photosynthesis, such as certain dinoflagellate algae species and species of the genus Prototheca.

In connection with fatty acid length, “mid-chain” shall mean C8 to C16 fatty acids.

In connection with a recombinant cell, the term “knockdown” refers to a gene that has been partially suppressed (e.g., by about 1-95%) in terms of the production or activity of a protein encoded by the gene.

Also, in connection with a recombinant cell, the term “ knockout” refers to a gene that has been completely or nearly completely (e.g., >95%) suppressed in terms of the production or activity of a protein encoded by the gene. Knockouts can be prepared by homologous recombination of a noncoding sequence into a coding sequence, gene deletion, mutation or other method.

An “oleaginous” cell is a cell capable of producing at least 20% lipid by dry cell weight, naturally or through recombinant or classical strain improvement. An “oleaginous microbe” or “oleaginous microorganism” is a microbe, including a microalga that is oleaginous (especially eukaryotic microalgae that store lipid). An oleaginous cell also encompasses a cell that has had some or all of its lipid or other content removed, and both live and dead cells.

A “polyunsaturated fatty acid” or “PUFA” is a fatty acid that contains more than one double bond. Omega-3, Omega-6 and Omega-9 fatty acids are common PUFAs present in many foods and include linoleic acid (C18:2) and linolenic acid (C18:3). Other, more highly unsaturated fatty acids including DHA (C22:6) and EPA (C20:5) are commonly referred to as fish oil. Additionally, polyunsaturated fatty acids also include fatty acids with conjugated double bonds.

In connection with a natural oil, a “profile” is the distribution of particular species or triglycerides or fatty acyl groups within the oil. A “fatty acid profile” is the distribution of fatty acyl groups in the triglycerides of the oil without reference to attachment to a glycerol backbone. Fatty acid profiles are typically determined by conversion to a fatty acid methyl ester (FAME), followed by gas chromatography (GC) analysis with flame ionization detection (FID). This method is described in applicant's WO2013/158938. The fatty acid profile can be expressed as one or more percent of a fatty acid in the total fatty acid signal determined from the area under the curve for that fatty acid. FAME-GC-FID measurement approximate weight percentages of the fatty acids.

“Recombinant” is a cell, nucleic acid, protein or vector that has been modified due to the introduction of an exogenous nucleic acid or the alteration of a native nucleic acid. Thus, e.g., recombinant cells can express genes that are not found within the native (non-recombinant) form of the cell or express native genes differently than those genes are expressed by a non-recombinant cell. Recombinant cells can, without limitation, include recombinant nucleic acids that encode for a gene product or for suppression elements such as mutations, knockouts, antisense, interfering RNA (RNAi) or dsRNA that reduce the levels of active gene product in a cell. A “recombinant nucleic acid” is a nucleic acid originally formed in vitro, in general, by the manipulation of nucleic acid, e.g., using polymerases, ligases, exonucleases, and endonucleases, using chemical synthesis, or otherwise is in a form not normally found in nature. Recombinant nucleic acids may be produced, for example, to place two or more nucleic acids in operable linkage. Thus, an isolated nucleic acid or an expression vector formed in vitro by ligating DNA molecules that are not normally joined in nature, are both considered recombinant for the purposes of this invention. Once a recombinant nucleic acid is made and introduced into a host cell or organism, it may replicate using the in vivo cellular machinery of the host cell; however, such nucleic acids, once produced recombinantly, although subsequently replicated intracellularly, are still considered recombinant for purposes of this invention. Similarly, a “recombinant protein” is a protein made using recombinant techniques, i.e., through the expression of a recombinant nucleic acid.

A “sn-2 profile” is the distribution of fatty acids found at the sn-2 position of the triacylglycerides in the oil. A “regiospecific profile” is the distribution of triglycerides with reference to the positioning of acyl group attachment to the glycerol backbone without reference to stereospecificity. In other words, a regiospecific profile describes acyl group attachment at sn-⅓ vs. sn-2. Thus, in a regiospecific profile, POS (palmitate-oleate-stearate) and SOP (stearate-oleate-palmitate) are treated identically. A “stereospecific profile” describes the attachment of acyl groups at sn-1, sn-2 and sn-3. Unless otherwise indicated, triglycerides such as SOP and POS are to be considered equivalent. A “ fatty acid profile ” or “TAG profile” is the distribution of fatty acids found in the triglycerides with reference to connection to the glycerol backbone, but without reference to the regiospecific nature of the connections. Thus, in a TAG profile, the percent of SSO in the oil is the sum of SSO and SOS, while in a regiospecific profile, the percent of SSO is calculated without inclusion of SOS species in the oil. In contrast to the weight percentages of the FAME-GC-FID analysis, triglyceride percentages are typically given as mole percentages; that is the percent of a given TAG molecule in a TAG mixture. Methods for determining the regiospecific profile is found in Applicant's WO2013/158938.

### General

Illustrative embodiments of the present invention feature uses of high stability (HS) and high-stability-high-oleic oil (HSHO) produced by recombinant oleaginous cells. Optionally, the cell are microalgal cells, optionally classified as Chlorophyta, Trebouxiophyceae, Chlorellales, Chlorellaceae, or Chlorophyceae, Chlorella, or Prototheca. Specific examples of microalgal cells include those of the species Prototheca moriformis or Chlorella protothecoides. These cells have been genetically engineered to produce triglyceride oils with altered fatty acid profiles. In particular, the cells produce oils with 5%, 4%, 3%, 2%, 1%, 0.5%, 0.3%, 0.2%, 0.1%, 0.05% or less of polyunsaturated fatty acids or of linoleic acid. Such oils can be produced by knockout, knockdown, or promoter hijack of a fatty acid desaturase gene (e.g., FAD2/FADc). See WO2013/158938. These oils can feature a very high oxidative stability; e.g., as measured by a test using the AOCS Cd 12b-92 standard. Optionally, the oils are also stabilized with added antioxidants such as tocopherols, and/or ascorbyl palmitate or synthetic antioxidants. In specific examples, the OSI induction time of the oil in a Rancimat oxidative stability analyzer is at least 20 hours at 110° C. without the addition of antioxidants. Optionally, a natural oil is produced by RBD (refining, bleaching and deodorization) treatment of a natural oil from an oleaginous cell, the oil comprises between 0.001% and 5%, preferably between 0.001% and 2% polyunsaturated fatty acids and has an OSI induction time exceeding 30 hours at 110° C.

### Minor Oil Components

The oils in some cases are made using a microalgal host cell. As mentioned above, the microalga can be, without limitation, fall in the classification of Chlorophyta, Trebouxiophyceae, Chlorellales, Chlorellaceae, or Chlorophyceae. It has been found that microalgae of Trebouxiophyceae can be distinguished from vegetable oils based on their sterol profiles. Oil produced by Chlorella protothecoides was found to produce sterols that appeared to be brassicasterol, ergosterol, campesterol, stigmasterol, and β-sitosterol, when detected by GC-MS. This method of detection generally does not distinguish between the two possible stereoisomers at C-24 in the absence of special conditions. However, sterols produced by green algae (e.g. Chlorophyta and specifically Chlorella) have a C2413 stereochemistry (J. K. Volkman, Sterols in Microorganisms, 2003, 60:495-506). Thus, molecules detected and reported as campesterol, stigmasterol, and β-sitosterol, are actually their C24 epimers 22,23-dihydrobrassicasterol, poriferasterol and clionasterol, respectively.

| Sterol | Stereoisomer (common name) | Systematic name* |
|---|---|---|
| 24-methylcholest-5-en-3-ol | Campesterol | (24R)-24-methylcholest-5-en-3β-ol |
| | 22,23-dihydrobrassicasterol | (24S)-24-methylcholest-5-en-3β-ol |
| | (□5-ergostenol) | |
| 24-ethylcholest-5-en-3-ol | β-Sitosterol | (24R)-24-ethylcholest-5-en-3β-ol |
| | Clionasterol | (24S)-24-ethylcholest-5-en-3β-ol |
| 5,22-cholestadien-24-ethyl-3-ol | Stigmasterol | (24S)-24-ethylcholesta-5,22-dien-3β-ol |
| | Poriferasterol | (24R)-24-ethylcholesta-5,22-dien-3β-ol |

*In the nomenclature, 24α = 24(R) and 24β = 24(S) when side chain is saturated;
24α = 24(S) and 24β = 24(R) when side chain contains a Δ22 double bond.

Thus, the oils produced by the microalgae described above can be distinguished from plant oils by the presence of sterols with C24β stereochemistry and the absence of C24α stereochemistry in the sterols present. For example, the oils produced may contain 22,23-dihydrobrassicasterol while lacking campesterol; contain clionasterol, while lacking in β-sitosterol, and/or contain poriferasterol while lacking stigmasterol. Alternately, or in addition, the oils may contain significant amounts of Δ⁷-poriferasterol.

In one embodiment, the oils provided herein are not vegetable oils. Vegetable oils are oils extracted from plants and plant seeds. Vegetable oils can be distinguished from the non-plant oils provided herein on the basis of their oil content. A variety of methods for analyzing the oil content can be employed to determine the source of the oil or whether adulteration of an oil provided herein with an oil of a different (e.g. plant) origin has occurred. The determination can be made on the basis of one or a combination of the analytical methods. These tests include but are not limited to analysis of one or more of free fatty acids, fatty acid profile, total triacylglycerol content, diacylglycerol content, peroxide values, spectroscopic properties (e.g. UV absorption), sterol profile, sterol degradation products, antioxidants (e.g. tocopherols), pigments (e.g. chlorophyll), d13C values and sensory analysis (e.g. taste, odor, and mouth feel). Many such tests have been standardized for commercial oils such as the Codex Alimentarius standards for edible fats and oils.

Sterols contain from 27 to 29 carbon atoms (C27 to C29) and are found in all eukaryotes. Animals exclusively make C27 sterols as they lack the ability to further modify the C27 sterols to produce C28 and C29 sterols. Plants however are able to synthesize C28 and C29 sterols, and C28/C29 plant sterols are often referred to as phytosterols. The sterol profile of a given plant is high in C29 sterols, and the primary sterols in plants are typically the C29 sterols β-sitosterol and stigmasterol. In contrast, the sterol profile of non-plant organisms contain greater percentages of C27 and C28 sterols. For example the sterols in fungi and in many microalgae are principally C28 sterols. The sterol profile and particularly the striking predominance of C29 sterols over C28 sterols in plants has been exploited for determining the proportion of plant and marine matter in soil samples (Huang, Wen-Yen, Meinschein W. G., “Sterols as ecological indicators”; Geochimica et Cosmochimia Acta. Vol 43. pp 739-745).

Sterol profile analysis is a particularly well-known method for determining the biological source of organic matter. Campesterol, β-sitosterol, and stigmasterol are common plant sterols, with β-sitosterol being a principle plant sterol. For example, β-sitosterol was found to be in greatest abundance in an analysis of certain seed oils, approximately 64% in corn, 29% in rapeseed, 64% in sunflower, 74% in cottonseed, 26% in soybean, and 79% in olive oil (Gul et al. J. Cell and Molecular Biology 5:71-79, 2006).

Oil isolated from Prototheca moriformis strain UTEX1435 were separately clarified (CL), refined and bleached (RB), or refined, bleached and deodorized (RBD) and were tested for sterol content according to the procedure described in JAOCS vol. 60, no.8, August 1983. Results of the analysis are shown below (units in mg/100 g) in Table 1.

TABLE 1
Sterol content of oils.

| | | | | | Refined, |
|---|---|---|---|---|---|
| | | | | Refined & | bleached, & |
| | Sterol | Crude | Clarified | bleached | deodorized |
| 1 | Ergosterol | 384 (56%) | 398 (55%) | 293 (50%) | 302 (50%) |
| 2 | 5,22-cholestadien- | 14.6 (2.1%) | 18.8 (2.6%) | 14 (2.4%) | 15.2 (2.5%) |
| | 24-methyl-3-ol | | | | |
| | (Brassicasterol) | | | | |
| 3 | 24-methylcholest-5- | 10.7 (1.6%) | 11.9 (1.6%) | 10.9 (1.8%) | 10.8 (1.8%) |
| | en-3-ol (Campesterol or | | | | |
| | 22,23-dihydrobrassicasterol) | | | | |
| 4 | 5,22-cholestadien-24- | 57.7 (8.4%) | 59.2 (8.2%) | 46.8 (7.9%) | 49.9 (8.3%) |
| | ethyl-3-ol (Stigmasterol | | | | |
| | or poriferasterol) | | | | |
| 5 | 24-ethylcholest-5-en- | 9.64 (1.4%) | 9.92 (1.4%) | 9.26 (1.6%) | 10.2 (1.7%) |
| | 3-ol (β-Sitosterol or | | | | |
| | clionasterol) | | | | |
| 6 | Other sterols | 209 | 221 | 216 | 213 |
| | Total sterols | 685.64 | 718.82 | 589.96 | 601.1 |

These results show three striking features. First, ergosterol was found to be the most abundant of all the sterols, accounting for about 50% or more of the total sterols. The amount of ergosterol is greater than that of campesterol, β-sitosterol, and stigmasterol combined. Ergosterol is steroid commonly found in fungus and not commonly found in plants, and its presence particularly in significant amounts serves as a useful marker for non-plant oils. Secondly, the oil was found to contain brassicasterol. With the exception of rapeseed oil, brassicasterol is not commonly found in plant based oils. Thirdly, less than 2% β-sitosterol (or clionasterol) was found to be present. β-sitosterol is a prominent plant sterol not commonly found in microalgae, and its presence particularly in significant amounts serves as a useful marker for oils of plant origin. As the specific stereoisomer of 24-ethylcholest-5-en-3-ol was not confirmed, this sterol was most likely clionosterol and not β-sitosterol in view of the current understanding of the sterols of the green algae (J. K. Volkman, Sterols in Microorganisms, 2003, 60:495-506). In summary, Prototheca moriformis strain UTEX1435 has been found to contain both significant amounts of ergosterol and only trace amounts of 24-ethylcholest-5-en-3-ol (as β-sitosterol or clionasterol) as a percentage of total sterol content. Accordingly, the ratio of ergosterol:β-sitosterol (or clionasterol) and/or in combination with the presence of brassicasterol can be used to distinguish this oil from plant oils.

In some embodiments, the oil content of an oil provided herein contains, as a percentage of total sterols, less than 20%, 15%, 10%, 5%, 4%, 3%, 2%, or 1% β-sitosterol and/or clionasterol.

In some embodiments, the oil is free from one or more of β-sitosterol, campesterol, or stigmasterol. In some embodiments the oil is free from β-sitosterol. In some embodiments the oil is free from campesterol. In some embodiments the oil is free from stigmasterol.

In some embodiments, the oil content of an oil provided herein comprises, as a percentage of total sterols, less than 20%, 15%, 10%, 5%, 4%, 3%, 2%, or 1% 24-ethylcholest-5-en-3-ol. In some embodiments, the 24-ethylcholest-5-en-3-ol is clionasterol. In some embodiments, the oil content of an oil provided herein comprises, as a percentage of total sterols, at least 1%, 2%, 3%, 4%, 5%, 6%, 7%, 8%, 9%, or 10% clionasterol.

In some embodiments, the oil content of an oil provided herein contains, as a percentage of total sterols, less than 20%, 15%, 10%, 5%, 4%, 3%, 2%, or 1% 24-methylcholest-5-en-3-ol. In some embodiments, the 24-methylcholest-5-en-3-ol is 22,23-dihydrobrassicasterol. In some embodiments, the oil content of an oil provided herein comprises, as a percentage of total sterols, at least 1%, 2%, 3%, 4%, 5%, 6%, 7%, 8%, 9%, or 10% 22,23-dihydrobrassicasterol.

In some embodiments, the oil content of an oil provided herein contains, as a percentage of total sterols, less than 20%, 15%, 10%, 5%, 4%, 3%, 2%, or 1% 5,22-cholestadien-24-ethyl-3-ol. In some embodiments, the 5,22-cholestadien-24-ethyl-3-ol is poriferasterol. In some embodiments, the oil content of an oil provided herein comprises, as a percentage of total sterols, at least 1%, 2%, 3%, 4%, 5%, 6%, 7%, 8%, 9%, or 10% poriferasterol.

In some embodiments, the oil content of an oil provided herein contains ergosterol or brassicasterol or a combination of the two. In some embodiments, the oil content contains, as a percentage of total sterols, at least 5%, 10%, 20%, 25%, 35%, 40%, 45%, 50%, 55%, 60%, or 65% ergosterol. In some embodiments, the oil content contains, as a percentage of total sterols, at least 25% ergosterol. In some embodiments, the oil content contains, as a percentage of total sterols, at least 40% ergosterol. In some embodiments, the oil content contains, as a percentage of total sterols, at least 5%, 10%, 20%, 25%, 35%, 40%, 45%, 50%, 55%, 60%, or 65% of a combination of ergosterol and brassicasterol.

In some embodiments, the oil content contains, as a percentage of total sterols, at least 1%, 2%, 3%, 4% or 5% brassicasterol. In some embodiments, the oil content contains, as a percentage of total sterols less than 10%, 9%, 8%, 7%, 6%, or 5% brassicasterol.

In some embodiments the ratio of ergosterol to brassicasterol is at least 5:1, 10:1, 15:1, or 20:1.

In some embodiments, the oil content contains, as a percentage of total sterols, at least 5%, 10%, 20%, 25%, 35%, 40%, 45%, 50%, 55%, 60%, or 65% ergosterol and less than 20%, 15%, 10%, 5%, 4%, 3%, 2%, or 1% β-sitosterol. In some embodiments, the oil content contains, as a percentage of total sterols, at least 25% ergosterol and less than 5% β-sitosterol. In some embodiments, the oil content further comprises brassicasterol.

In some embodiments the primary sterols in the microalgal oils provided herein are sterols other than β-sitosterol and stigmasterol. In some embodiments of the microalgal oils, C29 sterols make up less than 50%, 40%, 30%, 20%, 10%, or 5% by weight of the total sterol content.

In some embodiments the microalgal oils provided herein contain C28 sterols in excess of C29 sterols. In some embodiments of the microalgal oils, C28 sterols make up greater than 50%, 60%, 70%, 80%, 90%, or 95% by weight of the total sterol content. In some embodiments the C28 sterol is ergosterol. In some embodiments the C28 sterol is brassicasterol.

The stable carbon isotope value δ13C ( 0/00) of the oils can be related to the δ13C value of the carbon feedstock used. Optionally, the carbon feedstock is sucrose or glucose or sugars derived from depolymerized cellulosic material. The stable carbon isotope value δ13C is an expression of the ratio of ¹³C/¹²C relative to a standard (e.g. PDB, carbonite of fossil skeleton of Belemnite americana from Peedee formation of South Carolina). In some embodiments the oils are derived from oleaginous organisms heterotrophically grown on sugar derived from a C4 plant such as corn or sugarcane. In some embodiments the δ13C ( 0/00) of the oil is from −10 to −17 0/00 or from −13 to −16 0/00. When added to a food, the oil may alter the carbon ratio of the food in proportion to the amount of oil added.

### Elimination of Chelating Agents

In some embodiments, the invention provides methods of reducing or eliminating the addition of metal chelators, such as ethylenediaminetetraacetic acid and salts of ethylenediaminetetraacetic acid (collectively referred as EDTA) and dimercaprol to a food. EDTA is added to many food products, including salad dressings, spreads, drinkable foods such as dairy and non-dairy drinks, yogurts, juices, sports drinks, cheese, cheese products, dips for snacks, fruit and other foods to minimize oxidative degradation of the food.

EDTA is a metal chelator that binds to metals. Metal ions such as Fe⁻⁺ catalyze the oxidation of many food components. Trace metals found in foods act as catalysts for oxidation of fats and lipids. For example, in the case of linolenic acid, linoleic acid or other polyunsaturated fatty acids, the unstable double bonds are susceptible to degradation by metals in the foods. Trace metals also can produce undesirable effects such as discoloration and turbidity. Chelators work by binding to metals (e.g., Fe, Co, Cu, Al, etc.) and the metal/EDTA complex minimizes the catalytic activity of the metals, thereby minimizing oxidation. Because HSHO and HO oils are far more stable than conventional vegetable or animal oils, the need to add EDTA to foods is eliminated or reduced.

### Specific Applications to Food

In various embodiments, use of HS or HSHO oil can provide various benefits to the producer or consumer of the food. These potential benefits include:
Production by fermentation can reduce environmental risks and fatty acid profile variations seen with seed crops.
Reduced trans-fat (e.g., negligible or “zero” grams per serving)
High monounsaturates for HSHO oil (e.g., >70, 80 or 90% monounsaturates)
Low levels of saturated fats (e.g., <8, 5, 3, 2 or 1%)
High oxidative stability (e.g., OSI at 110° C. of 45-50 hours without antioxidants or 5-10 hours at 150° C. with antioxidants)
Reduced tendency for polymerization when heated
Excellent shelf-life protection
Neutral flavor and/or color
Resistant to clouding

### Potato Chip and Snack Frying

Potato, vegetable or grain-based chips and other fried snacks absorb oil during frying. For example, the chips/snacks can absorb 30% of their weight in oil. The shelf life of the snack is thus tied to the oxidative stability of the oil in the snack. As a result of the poor oxidative stability of common vegetable oils (e.g., soybean oil), expensive air-tight packaging such as metalized polymer material is often used. In addition, nitrogen sparging is often used to displace oxygen in the package.

By frying the snack in a HS or HSHO oil (e.g., microalgal oil), the shelf life of the snack can be extended, avoiding the need for air-tight packaging and/or nitrogen sparging. Shelf life can be established by consumer acceptability studies such as the amount of time needed for a tasting panel to identify the product as stale or smelling rancid. Testing can be performed by using; e.g. using a Schaal oven as described in the Examples below. For example, the shelf-life in air at atmospheric pressure and 25° C. can be extended by 10, 20, 30, 50, 100% or more relative to an equivalent snack fried in commercially available vegetable oils. The snack itself may have a fatty acid profile having less than 5, 4, 3, 2, or 1% polyunsaturates. In another embodiment, the frying oil absorbed by the snack during frying has a fatty acid profile having less than 5, 4, 3, 2, or 1% polyunsaturates

Another benefit of frying in this oil is that the frying equipment will suffer less polymer build-up and produce less volatile compounds. Polymer build-up occurs during the frying process from the polymerization of the polyunsaturated fatty acids. Volatile compounds are created from the degradation products of the oil during the frying process.

In accordance with specific embodiments of the present invention, there is a method for frying a snack chip comprising heating a the chip to frying temperature (e.g., 150 ° C., 160 ° C., 170° C., 180 ° C., 185° C., 190 ° C., 200 ° C., 210 ° C., 220 ° C. or higher) in a microalgal oil having less than 3%, 2% or 1% polyunsaturates. The snack product so produced can have a shelf life that is extended by 10, 20, 30, 50, 100% or more relative to commodity vegetable oil (e.g., Crisco® brand) according to the consumer test mentioned above.

### Use of High Stability Oil For Coating and Spray Applications.

The stability and free-flowing properties of the HS and HSHO oils can be used advantageously for spraying the oil onto or otherwise coating foods such as dried fruit, nuts, crackers, cereals, or finely ground materials such as seasonings and dehydrated mixes (e.g., powders that can be reconstituted into soups, dressings, gravies, etc.) to provide a protective coating and to extend the shelf-life of the products by protecting against oxidation. The sprayed oil can also function as a stable sticking agent in certain spraying applications; e.g., to help seasonings and flavors adhere to a food product. The low polyunsaturates result in performance comparable or superior to partially hydrogenated vegetable oils but without the undesirable trans fats, or else comparable or superior to palm oil but with more environmental advantages and, as in the case of HSHO oils, lower amounts of saturated fats. The oils are also more stable than currently available high oleic seed oils. The improved stability can also allow for less expensive or more environmentally sustainable (e.g. compostable) packaging.

For certain dehydrated food items, coating with the oil can improve mouthfeel upon rehydration and/or cooking relative to uncoated or soybean-oil-coated controls. These products may also benefit from the extended shelf-life mentioned above.

Another benefit of using the oil for coating is that it can provide anti-dusting of powdered or finely ground materials without causing rancidity.

In accordance with specific embodiments of the present invention, there is a method for coating a food item such as a nut, cracker, potato flake, powder or dried fruit comprising spraying-on a microalgal oil having less than 3%, 2% or 1% polyunsaturates. The food item so produced can have a shelf life that is extended by 10, 20, 30 ,50, 100% or more relative to commodity vegetable oils (e.g., Crisco® brand soybean oil) according to the consumer test mentioned above.

### Spray For Heated Surface Coating

In an embodiment, the HS or HSHO oil is sprayed onto pans, baking sheets or other heated surfaces prior to food contact. As a result of the high stability, the surface can be reused a greater number of times than if soybean oil or other vegetable oil was used. The oil can replace mineral oil or partially hydrogenated oils while still providing the same performance. Improved stability can be determined by a Schaal oven test.

### Color and Flavor Carrier Oil

Food colors and flavors are expensive ingredients and thus need a high stable, bland, and edible carrier. The HS or HSHO products can be used to replace hydrogenated oils in such applications. The flavorant, colorant and/or odorant is formulated with HS or HSHO oil and is sprayed onto foods, such as crackers, chips, nuts, snack foods and other foods. The stability of the HS or HSHO oil improves taste and shelf life of the food. After formulating a flavor or color in the oil, sensory testing can be performed as a function of storage time.

### Food Grade Lubricant

The HS or HSHO oil can be used in food manufacturing to lubricate moving parts such as gears, bearings, etc. Many producers currently use petroleum-based products such as mineral oil for lubrication. This is sub-optimal because the surfaces often come into contact with food. The high stability of the HS and HSHO oils meets the performance needs for food-grade lubricants, while being safe for consumption and fully biodegradable.

### Canned Meats/Seafood

The HSHO or HS oils can be used to surround meats in the canning process. Oils are commonly used for packing canned seafood; e.g., tuna, sardines, anchovies, or salmon or canned chicken, canned beef, canned pork, canned ham or other canned meats including blends of meats that are canned. The oil is useful for this application because it is relatively bland, highly stable, and for HSHO, low in saturated fat.

### Spreads and Margarines

Spreads, margarines or other food product can be made with the HSHO or HS oils. For example, the HSHO or HS oil can be used to make an edible W/O (water/oil) emulsion spread comprising 70-20 wt. % of an aqueous phase dispersed in 30-80 wt. % of a fat phase which fat phase is a mixture of 50-99 wt. % of a vegetable triglyceride oil A and 1-50 wt. % of a structuring triglyceride fat B, which fat consists of 5-100 wt. % of a hardstock fat C and up to 95 wt. % of a fat D, where at least 45 wt. % of the hardstock fat C triglycerides consist of SatOSat triglycerides and where Sat denotes a fatty acid residue with a saturated C18-C24 carbon chain and O denotes an oleic acid residue. In one embodiment, the hardstock fat C has been obtained by fractionation of a vegetable oil. In one embodiment, the hardstock fat C has not been obtained by fractionation, hydrogenation, esterification or interesterification. In yet another embodiment, the hardstock fat C can be a natural fat produced by a cell according to the methods of Applicant's WO2013/158938, WO2015/051319, herein incorporated by reference. Accordingly, the hardstock fat can be a fat having a regiospecific profile having at least 30, 40, 50, 60, 70, 80, or 90% SOS. Examples of commercially available hardstock fat C include shea, shea stearin fraction, fractionated palm kernel oil, fractionated palm oil and other fats that are solid at room temperature. The W/O emulsion can be prepared by methods known in the art, including in U.S. Pat. No. 7,118,773.

In another embodiment, the invention is a spread or margarine comprising total saturated fat content of less than 20 grams, of less than 18 gram, of less than 15 gram, of less than 12 grams, of less than 10 grams, or of less than 5 grams per 100 grams of total fat. Example 7 provides recipes for reducing the total saturated fat content of margarine from 24 grams to 10 gram per 100 grams of fats present in the margarine.

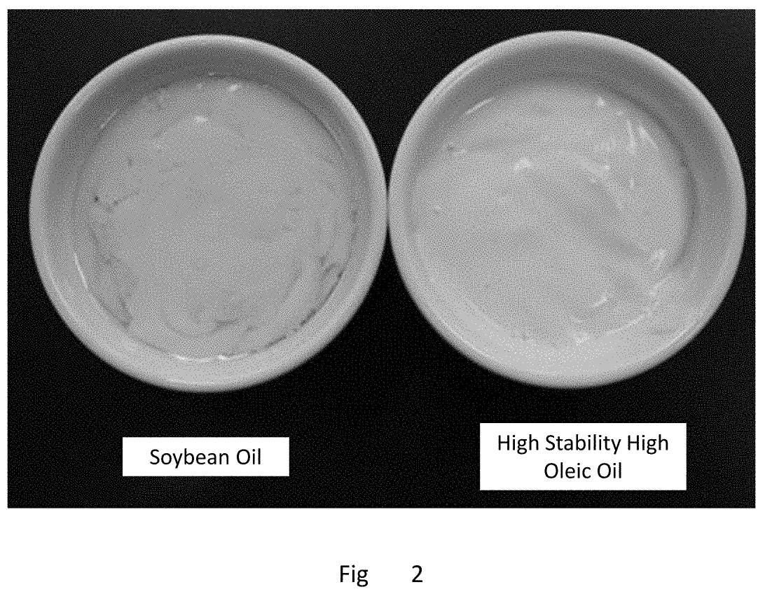

Example 6 provides a mayonnaise in which EDTA was removed from the recipe. FIG. 2 is a photograph showing the results of an accelerated aging test in which mayonnaise was made with soybean oil or with HSHO oil. The photograph clearly shows that after accelerated aging for 10 days at 50° C., the mayonnaise made with soybean oil has degraded significantly when compared to the mayonnaise made with HSHO oil. The HSHO oil mayonnaise has a longer shelf-life

### Non-Dairy Creamer

Hydrogenated vegetable oils are used in many non-dairy creamers. The vegetable oils are hydrogenated to increase the stability of the oil by decreasing the polyunsaturated fat content of the vegetable oil. Partially hydrogenated soybean oil is a common ingredient in non-dairy creamers. Partial or complete replacement of hydrogenated vegetable oil in non-dairy creamers with HS or HSHO oil provides a product with long shelf life.

### Emulsification

We have observed that the HSHO oil provide superior emulsification relative to soybean oil. Due to the low level of saturated fats (e.g., <5%) the oil will have a very low cloud point, which is good for use in salad dressings.

### Baking

Use of HSHO in baked goods improves fine texture and moisture retention; e.g., in cakes. Thus, in an embodiment, a cake or other baked good is made with HSHO. The resulting cake has improved texture and/or moisture retention relative to a soybean-oil control.

### Dry HSHO as a Nutritional Supplement

The HSHO can be spray-dried to produce a granulated material that can be used as a nutritional supplement. Oils can be spray dried with polysaccharides such as maltodextrin, acacia gum, modified cellulose, or other hydrocolloids, lecithins or proteins such as sodium casseinate.

### Dairy Substitute

HSHO (e.g. with >85% oleic content) can be used to mimic dairy or breast milk in dairy substitutes and meal replacement products.

### Enzymatic Transesterification or Interesterification

The HSHO oil can be enzymatically transesterified or interesterified with another fat, fatty acids, or fatty acid esters to produce a cocoa butter equivalent, extender or other such product. For example, a fat such as tallow, lard, fully or partially hydrogenated vegetable oil (e.g., fully hydrogenated soybean oil), palm stearine, palm kernel oil, or palm oil can be interesterified with HSHO to give triglycerides with a high percentage of oleate at the sn-2 position.

Cocoa butter equivalents (CBE) are fats that have similar triacylglycerol compositions and physical properties to cocoa butter. In an embodiment, lipase-catalyzed transesterification can be used to synthesize CBE. A high oleic oil microalgal oil such as HSHO can be enriched with stearic and palmitic acids in the sn-1 and sn-3 positions using a regiospecific enzyme. Advantages of using a microalgal oil can include higher levels of oleic acid at the sn-2 position and lower levels of linoleic acid acyl moieties in the final product. In other words, a higher level of saturated-monounsaturates-saturated triacylglycerides may result.

In a specific embodiment, a microalgal HSAO natural oil is produced having a fatty acid profile characterized by greater than 80% oleic acid and less than 5% linoleic acid. Optionally, the fatty acid profile is characterized by greater than 85% oleic acid and less than 3% linoleic acid. The oil is enzymatically transesterified with a composition (e.g., triglyceride, fatty acid, fatty acid ester) having greater than 60, 70%, 80% 90%, or 95% of (in sum) palmitic acid and stearic acid. The result can be an oil that with triacylglycerides that are predominantly (>50%) of the saturated-monounsaturated-saturated type. This oil/fat can be used in food or cosmetic applications, including as a cocoa butter equivalent, replacement, or extender in candy, chocolate, moisturizer, etc.

The HSHO oil can be produced, for example, according to the methods of WO2013/158938. For example a microalga can be genetically engineered to reduce or knockout expression of at least one FATA allele, overexpress a KASII allele, and/or reduce or knockout expression of a FADc fatty acid desaturase allele. Optionally FADc is placed under a regulatable promoter and propagated under permissive conditions followed by an oil production stage under restrictive conditions to obtain a low polyunsaturate oil (e.g., with less than 5, 4, 3, 2, 1, or 0.5% linoleic acid).

The resulting oil can have a saturate-oleate-saturate content of greater than 40, 50, 60, 70, 80, or 90%. Optionally, the saturate-linoleate-saturate content is less than 20, 10, 5, 4, 3, 2, or 1%. For example, saturate-oleate-saturate can be greater than 50% and the saturate-linoleate-saturate can be less than 3%. Alternately, saturate-oleate-saturate can be greater than 60% and the saturate-linoleate-saturate can be less than 2%. Alternately, saturate-oleate-saturate can be greater than 70% and the saturate-linoleate-saturate can be less than 1%.

Examples 5 and 6 describe the synthesis of CBE via transesterification of an HSHO with saturated fatty acyl esters.

### Blending

The HSHO oil can be blended with a hardstock fat. The resulting blend may be used as a replacement for partially hydrogenated vegetable oil. For example, the blend may be used in a microwavable popcorn package. The packaged popcorn will be shelf stable, and the blended oil will not bleed through the packaging, and will not need to be refrigerated. Alternately, the HSHO can be used in microwavable popcorn without blending.

The HS or HSHO oil can also be blended with expensive oils such olive, avocado, or walnut oils without affecting the flavor. The shelf-life is also extended. Alternately, the oil can be blended with commodity oils such as canola or soybean to extend shelf-life.

The blending of HS or HSHO algal oil with one or more vegetable oils yields blended oils with increased thermal stability, lowered saturated fat content, and/or lowered polyunsaturated fat content, while preserving the sensory properties of the oil. For example, because HS and HSHO oil has a neutral taste, the blending of HS or HSHO algal oil with olive oil provides an oil that tastes like olive oil. Furthermore, because of the high oxidative stability of HS and HSHO oil, the blended oil will be more thermally stable than neat olive oil. The algal oil/olive oil blend is used in sauces, for example red or white pasta sauces, to reduce the costs, while providing the olive oil taste. The oil blends are used to lower the saturated fat content of dressings, including mayonnaise. For example, typically, mayonnaise is made with soybean oil. A mayonnaise made with a blend of soybean oil and HS or HSHO oil provides a product with lowered saturated fat and lowered polyunsaturated fat. Example 6 provides a mayonnaise recipe with lowered saturated fat and lowered polyunsaturated fat. Because of the lowered amount of polyunsaturated fat (C18:3 and C18:3), the shelf life of the mayonnaise is increased.

Blends of HSHO with a hardstock fat can be used as a barrier on certain food products for flavor encapsulation and to extend shelf life. The blend can be sprayed on packaged breakfast cereal to delay sogginess from contact with milk or on breaded products to maintain crispness. Blends with hardstocks can also be used to create shortening, margarine or other partially hydrogenated vegetable oil replacing compositions. Use of these blends can remove trans-fats, and lower saturated fat content while maintaining performance in terms of stability, crystal structure, melting properties and structure kinetics. Such blends can also be valuable in the frying of dough; e.g., doughnuts. Food service doughnut fryers currently use blends of palm-based oils or partially hydrogenated vegetable oils for frying. Saturated fatty acids are needed in the oil in order to prevent greasiness and to target a given mouthfeel. HSHO can be blended with palm or palm-kernel-based hardstock fat to give a healthier frying oil for doughnuts and other foods. The blended oil will also cause less oil absorption by the food, thus lowering the fat and caloric content of the food.

### EXAMPLES

Example 1. HSHO oil was produced using the methods of the Examples in WO2013/158938. A Prototheca moriformis strain comprised a FATA (acyl-ACP thioesterase) knockout, an exogenous yeast sucrose invertase, an overexpressed P. moriformis KASII gene, and hairpin RNA targeting the FAD2/FADc fatty acid desaturase gene. The result was a triglyceride oil having a fatty acid profile with about 85-90% oleic acid, less than 2% linoleic acid and less than 2.5% total polyunsaturates. The primary sterol was ergosterol. Rancimat OSI at 110° C. was 45-50 hours without antioxidants and was about 8 hours at 150° C. with antioxidants. By way of comparison, Canola oil was 18 hours and 1.3 hours, respectively.

TABLE 2
Fatty acid profile of the HSHO oil.

| Fatty Acid | % of total fatty acids (by FAME-GC analysis) |
|---|---|
| C10:0 | 0.02 |
| C12:0 | 0.02 |
| C14:0 | 0.4 |
| C16:0 | 3.9 |
| C18:0 | 3.4 |
| C18:1 | 87.6 |
| C18:2 | 2.0 |
| C18:3 alpha | 0.2 |

Example 2. The oil of Example 1 or a vegetable oil (blend of sunflower, corn and canola) purchased from a local grocery store was used to fry sliced potato chips (1.5 mm thick) at 177° C. (350° F.) until lightly brown. The chips are placed on a tray, exposed to air for varying periods of time after which a 6-person tasting panel tastes the chips for signs of freshness. The tasting panel fills out a questionnaire asking if the chips are unacceptably stale. When at least two of the tasters answers in the affirmative, the chips are considered to be stale. In this way, the shelf-lives of the chips made with the microalgal oil or control oil are determined. It is found that the microalgal oil produces chips with an improvement in shelf-life of at least 10%. In addition, the chips are packaged without using nitrogen sparging and the shelf-life is determined as above. The HSHO fried chips also give an improved shelf-life of at least 10% in this test. Sensory comparisons are done in terms of taste, smell and texture for the experimental and control product.

The nutritional profiles of the potato chips are shown in Table 3 below. The saturated fat content of the potato chips fried in HSHO was zero grams per serving but the saturated fat content of the potato chip fried in vegetable oil as 2 grams per serving

TABLE 3
Nutritional profile of potato chips
fried in vegetable oil and HSHO oil

| | Potato Chip Fried | Potato Chip Fried |
|---|---|---|
| | in Vegetable Oil | in HSHO Oil |
| | Serving Size (43 g) | Serving Size (43 g) |
| Total Fat | 16 grams | 16 grams |
| Saturated Fat | 2 grams | 0 grams |

Example 3. Potato chips are prepared as in Example 2 and subjected to an accelerated Schaal Oven storage stability test at 110° C. and the time to develop rancid odor is measured. An increase of storage time of at least 10% is observed.

Example 4. The oil of Example 1 is sprayed on dried fruit or dried vegetables, for example apples, apricots, bananas, berries, bilberries, blackberries, blueberries, boysenberries, cantaloupes, cherries, chokeberries, coconut, cranberries, currants, ginger, dates, elderberries, figs, freeze dried fruit, freeze dried vegetables, goji berries, gooseberries, grapes (raisins), guava, jackfruit, kiwis, lemons, mangos, nectarines, oranges, papaya, peaches, pears, persimmons, pineapples, plums (prunes), raspberries, strawberries, peppers, and tomatos and the dried fruit or dried vegetable are subjected to the tests of Example 2 and 3. The shelf-life is found to be extended by at least 10%.

### Example 5

### Synthesis of Cocoa Butter Equivalent

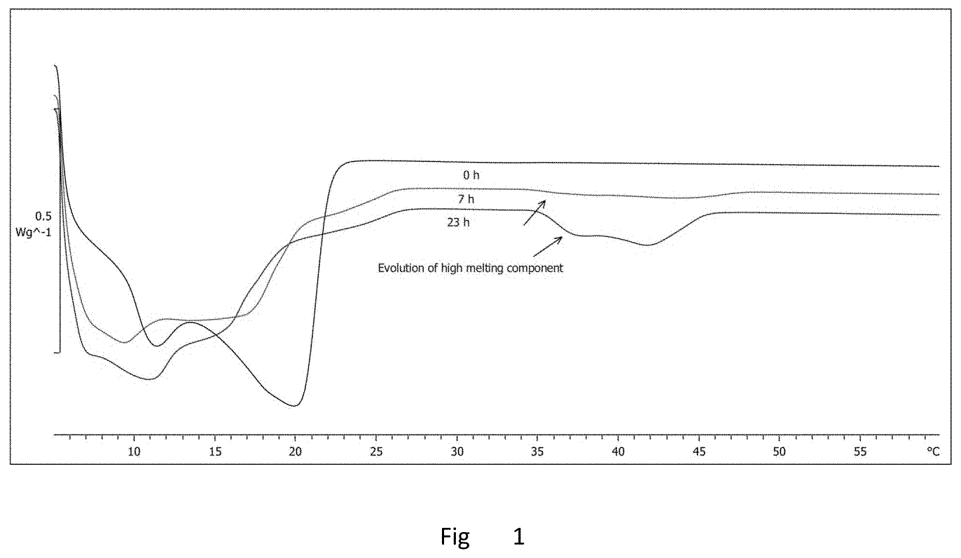

Fully hydrogenated soybean oil (FhSoyEE) and palm stearin (PS) were converted into ethyl esters (PSEE and FhSoyEE). The ethyl esters (1:1:3 molar ratio of HSHO:PSEE:FhSoyEE) were combined with the HSHO of Example 1 in the presence of 10% Lipozyme® lipase enzyme. The reaction was incubated in a shaking water bath at 200 rpm and 55° C. The reaction was followed by differential scanning calorimetry (DSC) and compared to controls high oleic sunflower oil and unreacted HSHO. The results are shown in FIG. 1. A high melting component (between about 36 and 45° C.) was observed to form over the reaction time course. The high melting component is believed to be saturate-oleoyl-saturate triacylglyceride. The fatty acid profiles of the various starting materials and comparator oils are given in Table 4, below.

TABLE 4
Fatty acid profiles of various starting
materials and comparator oils.

| | Percent Composition (%) | | | | |
|---|---|---|---|---|---|
| | C16:0 | C18:0 | C18:1 | C18:2 | |
| | Palmitic | Stearic | Oleic | Linoleic | |
| Oil | acid | acid | acid | acid | Other |
| Cocoa Butter | 25.2 | 35.5 | 35.2 | 3.2 | 0.9 |
| High Stability Algal Oil | 7.2 | 1.6 | 87.4 | 0.1 | 3.7 |
| High Oleic Sunflower Oil | 4.3 | 4.7 | 80.2 | 9.4 | 1.4 |
| Palm Stearin | 53.9 | 3.6 | 33.7 | 7.3 | 1.5 |
| Fully Hydrogenated | 16.1 | 83.9 | — | — | — |
| Soybean Oil | | | | | |

### Example 6

### Preparation of Mayonaise Without EDTA

Typically, mayonnaise is made with soybean oil and EDTA is added at 0.01%. Mayonnaise without EDTA was made using conventional soybean oil or HSHO oil. The ingredients and percent by mass are shown in Table 5 below. To make the mayonnaise, water, vinegar, lemon juice, mustard, salt and sugar were first mixed together. Next, the egg yolks and egg whites were added to the mixture and mixed until a uniform consistency was achieved. To the mixture, now containing all the ingredients except the oil, soybean oil or HSHO oil was slowly added while mixing with moderate shear. After all of the oil was added, the mixture was then processed through a colloid mill. The soybean oil mayonnaise with EDTA was not made for this example. The mayonnaises were tested for oganoleptic properties. Both soybean oil mayonnaise and the HSHO oil mayonnaise, both without EDTA, were judged organoleptically acceptable to the panel.

TABLE 5
Mayonnaise Recipe

| | Soybeal Oil | Soybeal Oil | HSHO Oil |
|---|---|---|---|
| | Mayonnaise (%) | Mayonnaise (%) | Mayonnaise (%) |
| Ingredients | with EDTA | without EDTA | without EDTA |
| HSHO Oil | 0 | 0 | 75.80 |
| Soybean Oil | 75.79 | 75.80 | 0 |
| Water | 11.35 | 11.35 | 11.35 |
| Egg Yolks | 3.53 | 3.53 | 3.53 |
| Egg Whites | 3.53 | 3.53 | 3.53 |
| Vinegar | 3.02 | 3.02 | 3.02 |
| Lemon Juice | 1.16 | 1.16 | 1.16 |
| Salt | 1.01 | 1.01 | 1.01 |
| Mustard | 0.35 | 0.35 | 0.35 |
| Sugar | 0.25 | 0.25 | 0.25 |
| EDTA | 0.01 | 0.0 | 0.0 |
| TOTAL | 100.00 | 100.00 | 100.00 |

The control mayonnaise made with soybean oil and the mayonnaise made with HSHO oil were then subjected to accelerated stability testing. Mayonnaise samples were placed in a heated chamber at 50° C. for ten days. After ten days, the structure of the mayonnaise made with soybean oil was breaking down and a clear separation between aqueous phase and the oil phase was clearly visible, in other words, the emulsion was broken down. In contrast, the emulsion of the mayonnaise made with the HSHO oil was maintained and no phase separation was observed. FIG. 2 shows a photograph of the soybean oil mayonnaise and the HSHO oil mayonnaise after the stability testing.

The nutritional profile of the HSHO oil mayonnaise is shown in Table 6 below. There is a 66% reduction in the saturated fat content of the HSHO oil mayonnaise when compared to the soybean oil mayonnaise. In addition, the amount of healthy monounsaturated fat, primarily C18:1, increased from 2 grams in the soybean oil mayonnaise to 9 grams in the HSHO oil mayonnaise.

TABLE 6
Nutritional profile of mayonnaise
made with soybean oil and HSHO oil

| | Soybean Oil | | HSHO Oil | |
|---|---|---|---|---|
| | Mayonnaise | | Mayonnaise | |
| | Serving Size (13 g) | | Serving Size (13 g) | |
| Total Fat | 10 | grams | 10 | grams |
| Saturated Fat | 1.5 | grams | 0.5 | grams |
| Polyunsaturated Fat | 6 | grams | 0 | grams |
| Monounsaturated Fat | 2 | grams | 9 | grams |

Example 7: Conventional margarines are made with liquid oil, hardstock fat and water. This example provides margarines in which the liquid oil is partially or fully replaced with HS oil and/or the hardstock fat is partially or fully replaced by an algal SOS oil. The hardstock is typically fractionated vegetable oil, often the high palmitic mid fraction of palm oil (HPMF). As the name suggests, HPMF is high in palmitic acid, a fully saturated fatty acid. Table 7 below shows the lipid portions of a margarine that can be with vegetable oils and margarines in which a portion or all of the vegetable oil is replaced with algal oils. Table 7 shows the reductions in the saturated fat content of the margarines. The margarine made from HPMF and HO oil has 15.2% total saturated fat, a reduction of 37%. The margarine made with SOS and HO oils has 9.6 grams of total saturated fat, a reduction of 60%.

TABLE 7
Lipid portions of a margarine.

| | Hardstock Fat | Liquid Fat | Total Saturated | |
|---|---|---|---|---|
| Margarine Formula | (saturated. Fat content) | (saturated fat content) | Fat Content | |
| Conventional margarine | 20 grams HPMF (12 | 80 grams (12 gram | 24 | grams |
| made with Veg. Oil | gram saturated. fat) | saturated fat) | | |
| Margarine made with | 20 grams HPMF (12 | 80 grams HO oil | 15.2 | grams |
| vegetable hardstock and | gram saturated. fat) | (3.2 grams saturated, | | |
| HO oil | | fat) | | |
| Margarine made with SOS | 10% algal SOS oil (6 | 90 grams HO oil | 9.6 | grams |
| oil and HO oil | gram saturated fat. | (3.6 grams saturated | | |
| | | fat) | | |

Although the above discussion discloses various exemplary embodiments of the invention, it should be apparent that those skilled in the art can make various modifications that will achieve some of the advantages of the invention without departing from the true scope of the invention.

1.-6. (canceled)

7. A spread or margarine comprising a vegetable or animal hardstock fat and algal high stability oil or algal high stability high oleic oil wherein the saturated fat content of the spread or margarine is reduced by at least 10% from a reference margarine made with a vegetable or animal hardstock fat and a vegetable or animal liquid oil.

8. The spread or margarine of claim 7, wherein the saturated fat content of the spread or margarine is reduced by at least 30% from the reference spread or margarine.

9. A spread or margarine comprising an algal hardstock fat and vegetable or animal liquid oil or algal high stability oil or algal high stability high oleic oil, wherein the saturated fat content of the spread or margarine is reduced by at least 10% from a reference spread or margarine made with a vegetable or animal hardstock fat and a vegetable or animal liquid oil.

10. The spread or margarine of claim 9, wherein the saturated fat content of the spread or margarine is reduced by at least 30% from the reference spread or margarine.

11. The spread or margarine of claim 9, wherein the saturated fat content of the spread or margarine is reduced by at least 50% from the reference spread or margarine.

12. The spread or margarine of claim 9, wherein the algal hardstock fat comprises at least 40% stearate-oleate-stearate (SOS triacylglycerides.

13. A method of making a spread or margarine comprising blending:
(a) an algal hardstock fat;
(b) algal high stability oil or algal high stability high oleic oil and/or vegetable or animal liquid oil; and
(c) water;
wherein the saturated fat content of the spread or margarine is reduced by at least 10% from a reference spread or margarine made with a vegetable or animal hardstock fat and a vegetable or animal liquid oil.

14. The method of claim 13, wherein the spread or margarine comprises algal hardstock fat and vegetable or animal liquid oil.

15. The method of claim 14, wherein the algal hardstock fat comprises at least 40% algal stearate-oleate-stearate (SOS) triglycerides.

16. The method of claim 13, wherein the saturated fat content of the spread or margarine is reduced by at least 30% from the reference spread or margarine.

17. The method of claim 16, wherein the saturated fat content of the spread or margarine is reduced by at least 50% from the reference spread or margarine.

18.-26. (canceled)

27. The method of claim 13, wherein the spread or margarine comprises a total saturated fat content of less than 20 grams per 100 gram of fats present in the spread or margarine.

28. The method of claim 27, wherein the spread or margarine comprises a total saturated fat content of less than 10 grams per 100 grams of fats present in the spread or margarine.

29. The spread or margarine of claim 9, wherein the spread or margarine comprises a total saturated fat content of less than 20 grams per 100 gram of fats present in the spread or margarine.

30. The spread or margarine of claim 29, wherein the spread or margarine comprises a total saturated fat content of less than 10 grams per 100 gram of fats present in the spread or margarine.
